(19) United States
(12) Patent Application Publication
(10) Pub. No.: US 2011/0050018 A1
(43) Pub. Date: Mar. 3, 2011

(54) Self sustaining generator system

(76) Inventor: Sylvester Rogers, Houston, TX (US)

(21) Appl. No.: 12/584,043

(22) Filed: Aug. 31, 2009

(51) Int. Cl. H02K 47/04; H02K 53/00

(52) U.S. Cl. 310/113; 415/916

(57) ABSTRACT

A self sustaining generator system 10 is provided. The generator system 10 includes a battery 12. The battery 12 is coupled through an output terminal thereof to an inverter 14 which converts the direct current battery output to an alternating current source of power. The generator system 10 of this invention is also provided with an electric motor 16 which is activated by the inverter 14 to amplify the signal generated by the inverter. An electric generator 18 is provided which is activated by the motor 16. As a result the generator 18 provides a first plurality of predetermined power output signals at selected output terminal 20 thereof and a second predetermined power output signal at a second output terminal 22 thereof which is feedback to the battery 12. This allows the battery 12 to be constantly charged thereby sustaining the operation of the generator system 10.

### TECHNICAL FIELD

This invention relates to a generator system and more particularly to a system which is used for generating power without the use of fossil fuels. Energy conservation is very important and of the utmost concern in today's society. This of course is because of the problems created because of society's ever growing seemingly unhealthy dependence on petroleum products. This is true even in the field of electric power generation and specifically with smaller systems such as generators. A good number of generators used today are those that require the use of fossil fuels such as, for example, petroleum products. These are generally high in fuel consumption, that is, they are not very fuel efficient. This of course can be very costly with the fluctuating cost of fuel. Additionally, these generators can have a deleterious effect on the environment.

Accordingly there have been a number of attempts to eliminate these concerns by designing more fuel efficient generators. Even this solution is still less than ideal because the generators still require the use of petroleum products.

Although there are a number of different generator arrangements there is an ongoing need to improve the generators and their efficiency as well as the need to minimize cost, complexity and the adverse effects on the environment. One way to address this need is to provide for a generator system that does not require the use of fossil fuels. This of course can minimize cost and complexity. Additionally, the concern for cost can be addressed by implementing a system having a self sustaining component.

### BACKGROUND ART

Attempts have been made to provide generators that require no petroleum products. One such device is illustrated in U.S. Pat. No. 6,661,110. This invention relates to a portable generator having a thyristor-based rectifier circuit and inverter circuit. The portable generator of this invention is a small generator for generating a single-phase AC voltage under PWN control which is subject to output fluctuations under a heavy load. The intention of this invention is to provide a portable generator which reduces the voltage fluctuation by rectifying an Ac voltage generated by an AC generator with a DC voltage generating circuit using a thyristor to charge a DC-power source unit and convert the output voltage of the DC power source unit with an inverter circuit. The inverter converts the DC voltage of the DC power source into a single-phase AC voltage to be supplied to the portable generator. The portable generator is also provided with a constant voltage control unit which effects control to keep the DC voltage of the DC power-source unit substantially constant by detecting the voltage of the DC power source unit, and controlling the continuity angle of the thyristors in the DC power source unit. Although devices such as these may achieve one of the desired result that is the elimination of the use of petroleum products, these arrangements may still be somewhat expensive because of the system complexity and because the system does not have a self sustaining component.

Another apparatus is disclosed in U.S. Pat. No. 7,095,126. This patent discloses an internal energy generating power source. The power source of this invention includes a battery which is used to initially supply power to an alternator and generator. Once the system is started the battery can be disconnected. The alternator and electric motor operate in combination to generate electrical power. The alternator supplies power to two inverters. One inverter output supplies part of its power to a lamp load device and part of its power to the electric motor/generator. The second inverter supplies power to the specific load devices that are connected to the system. This system does eliminate the use of petroleum products thus minimizing the adverse effects on the environment and to some extent it reduces cost. However although this system appears to have a self sustaining component a more efficient and cost effective system is desirable.

Therefore there is an ongoing need for a generator system that is petroleum free, uncomplicated, and cost effective while also being a self sustaining system.

### DISCLOSURE OF THE INVENTION

A self sustaining generator system is provided. The generator system of this invention includes a means for generating a direct current source of power. The direct current power source generating means is coupled through an output thereof to a means for converting the direct current power generated thereby to an alternating power source. The generator of this invention is also provided with a means for amplifying the alternating current power source. A generator is provided which is activated by the amplifying means. The generator provides a first predetermined power output for supplying power to external components and a second predetermined power output which is feedback to the direct current source generating means. This allows the direct current source generating means to be charged constantly so that the generator system is self sustaining. That is, the system can be sustained without any external power source.

### BRIEF DESCRIPTION OF THE DRAWING

The details of the invention will be described in connection with the accompanying drawing in which:

FIG. 1 is a block diagram of a self sustaining power generator system in accordance with the principles of the invention.

### BEST MODE FOR CARRYING OUT THE INVENTION

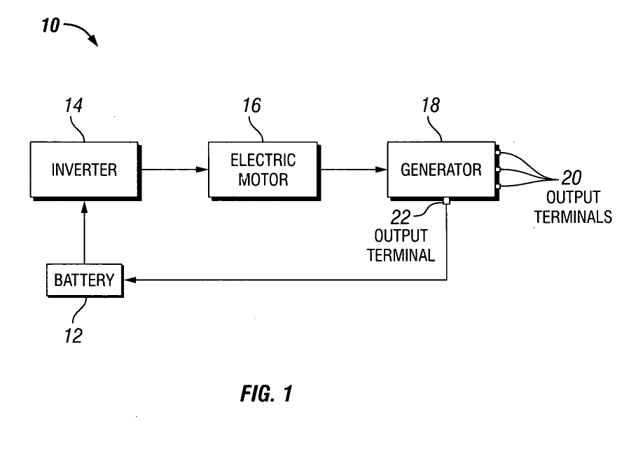

Referring to FIG. 1, a self sustaining generator system is shown, generally designated, by the numeral, 10. The generator system 10 includes a battery 12 which provides a direct current power source that is electrically coupled to an inverter 14. The battery 12 supplies the initial power to the system to initiate operation of the inverter 14. The inverter 14, converts the direct current power source from the battery 12 to an alternating current power source. The alternating current power source from the inverter 14 supplies power to an electric motor 16. The electric motor 16 amplifies or steps up the alternating current power from the inverter 14 thereby providing an amplified alternating current power source at an output thereof. The electric motor 16 supplies power to an electric generator 18. The generator 18 provides a plurality of first predetermined power outputs at output terminals 20 thereof. The generator 18 is also provided with another output 22. The output 22 provides an output signal which is feedback to the battery 12. This signal provides a constant source of power to the battery 12 thereby allowing the battery to be continually charged.

As illustrated in FIG. 1, when in use the generator system 10 is initiated by activation of the battery 12. Once activated the battery 12 supplies power to the inverter 14 which in turn starts the electric motor 16. Once the electric motor 16 is operational, the power generated by the electric motor is used to activate the generator 18. Upon activation of the generator 18 power is provided at the output terminals 20 to facilitate what ever external electrical operation is desired. The output 22 of the generator 18 feeds an output signal back to the battery 12. This is a key aspect of the present invention because the feedback signal from the generator 18, to the battery 12 provides a source of available power internal to the generator system 10 to constantly charge the battery. This of course provides the self sustaining component of the system that enables it to continually generate while in use.

The power output of the generator system 10 can vary depending on the predetermined output requirements of the generation system 10. This of course is ultimately determined by the specifications of the battery 12, inverter 14, motor 16 and generator 18 which can all be tailored to fit the desired system.

The invention has been shown and described in what is considered to be the most practical and preferred embodiment. However, it should be recognized that changes may be made by those skilled in the art without departing from the spirit and scope of the invention.

What is claimed:

1. A self sustaining system for generating power including:
a means for generating a predetermined amount of direct current power;
means for converting the signal from the direct current power generating means to an alternating current source of power;
first amplifying means electrically coupled to the direct current power converting means for amplifying the alternating current signal generated thereby so that a predetermined amplified alternating current source of power is generated;
a second amplifying means electrically coupled to the first amplifying means for amplifying the signal generated by the first amplifying means so that a first plurality of predetermined output signals are provided; and
means, included in the second amplifying means, for providing a second predetermined output signal to the direct current power generating means so that a constant signal is provided thereto to continually sustain the operation of the generating system.

2. A self sustaining generating system as defined in claim 1 wherein means for generating a predetermined amount of direct current power includes a battery.

3. A self sustaining generating system as defined in claim 2 wherein the converting means includes an inverter.

4. A self sustaining generating system as defined in claim 3 wherein first amplifying means includes an electric motor.

5. A self sustaining generating system as defined in claim 4 wherein the second amplifying means includes a generator which provides a first plurality of predetermined output signals.

6. A self sustaining generating system as defined in claim 5 wherein the means included in the second amplifying means for providing a second predetermined output signal to the direct current power source generating means includes the generator which provides a second predetermined output signal to the battery so that the battery is continually charged.
